(19) United States
(12) Patent Application Publication
(10) Pub. No.: US 2007/0261219 A1
(43) Pub. Date: Nov. 15, 2007

(54) Box

(76) Inventors: Arne Koch, Apeldoorn (NL); Gijsbert Michiel Zijlstra, Doesburg (NL); Leonardus Philomena Matheus Zautsen, Amsterdam (NL)

Correspondence Address: LADAS & PARRY, 26 WEST 61ST STREET, NEW YORK, NY, 10023, US

(21) Appl. No.: 11/628,330

(22) PCT Filed: Jun. 6, 2005
(86) PCT No.: PCT/NL05/00407

§ 371 Date: Jun. 28, 2007

(30) Foreign Application Priority Data
Jun. 4, 2004 (NL) 1026336
Sep. 10, 2004 (NL) 1027021

(51) Int. Cl. A61G 17/013

(52) U.S. Cl. 27/4

(57) ABSTRACT

Assembly for forming a box, comprising a bottom wall, two longitudinal walls, two end walls and an upper wall, wherein the walls are each plate-shaped and provided with coupling parts directly cooperating with each other and situated in the plane of the plate in question. All walls have been obtained from the same plate material.

The invention relates to a box or case, particularly to an assembly forming a kit for a box or case.

There is a need for boxes which in disassembled condition can be kept ready and be transported on demand in compact condition to the location of use, in order to be easily assembled there.

For instance in case of calamities, such as natural disasters, war and the like, causing many victims, there is a need for having large numbers of coffins at one's disposal as soon as possible in order to be able to quickly remove and store the dead bodies in them.

Such calamities however, usually take place at locations far from the industrialised world or far from urbanisation. Making coffins in sufficiently large quantities in situ often is impossible, due to lack of machines, material (particularly wooden boards) and manpower.

With kits for boxes that are known per se boxes can be held in store at other locations and be dispatched on demand to the location of need such as a disaster area. A problem however is that the boxes then need to be assembled in situ for which skilled manpower and tools are necessary.

It is an object of the invention to provide an assembly for a coffin, which can easily be assembled in situ into a box, such as for instance a coffin.

A further object of the invention is to provide an assembly for a box, that can be stored and transported in a compact condition.

A further object of the invention is to provide an assembly for a box that is easy to make.

According to one aspect of the invention at least one of these objects is achieved by means of an assembly for forming a box, comprising a bottom wall, two longitudinal walls, two end walls and an upper wall, wherein the walls are each plate-shaped and provided with coupling parts directly cooperating with each other and situated in the plane of the plate in question.

For connecting the walls of the box to each other no extra connection means are necessary so that the walls can quickly be joined without tools into a box by almost anybody.

It is noted that the longitudinal walls may be longer than the end walls, but may optionally also be shorter than the end walls or be equally long as the longitudinal walls.

Preferably all said walls are obtained from the same plate material, so that the walls can simply be obtained from one type of plate, for instance by cutting.

In a further development of the assembly according to the invention, the cooperating coupling parts comprise first coupling portions on the one wall and second coupling portions on the other wall to be connected thereto, wherein the first coupling portions comprise slits extending through the plate in question and the second coupling portions comprise lips projecting from the edge of the plate in question, each of which lips with said edge define a slot accessible at one end. In this way a simple slide or shift connection is obtained. The box can be assembled quickly, easily and reliably.

Preferably the slits have a thickness corresponding with the thickness of the plate, due to which a snug fit is obtained which increases the stability of the connection.

In a further embodiment the slot defined by the edges and the lips has a width corresponding with the thickness of the plate, due to which a tight interengagement is realised.

Alternatively the slot defined by the edge and the lips may have a width that is smaller than the thickness of the plate, wherein the plate provided with the related slit is locally provided with a recess contiguous to the slit for accommodation of at least a portion of the lip. The lip then projects less far from the surface.

In one embodiment the bottom wall is provided with aforementioned—particularly equally oriented—lips. The longitudinal walls here are supported on the lips. This embodiment may advantageously be supplemented with the measure that the lips formed at the bottom wall also form a handle.

The longitudinal walls may be provided with slits for the lips on the bottom wall.

In a further development of the assembly according to the invention the end walls are provided with slits for cooperation with lips provided at the end edges of the longitudinal walls, which lips preferably with their open end are upwardly oriented. In this way the end walls can be easily lowered onto the end edges of the longitudinal walls.

In a further development of the assembly according to the invention the longitudinal walls are provided at their upper edges with—particularly equally oriented—lips and the upper wall is provided with slits cooperating therewith. The upper wall or lid wall as well can thus easily be placed.

In a further development of the assembly according to the invention at least two of the walls are connected/connectable to each other by means of a snap connection. The snap connection may comprise a lip forming one unity with the one wall and which is able to enter into a snap connection with a recess in the other wall, wherein the other wall near the recess is provided with a snap cam. The lip may, when effecting the snap connection, be resiliently deformable.

In a further development of the assembly according to the invention, the upper wall can be accommodated in a confined manner between both end walls, as a result of which said wall remains reliably in its place.

If the walls are perfectly flat, stacking the walls is enhanced and a package that is as flat and stable as possible can be obtained, which can be stacked properly.

From a further aspect the invention provides an assembly for forming a box, comprising a bottom wall, two longitudinal walls, two end walls and an upper wall, wherein the walls have each been made of the same plate material and are connectable to each other by means of a coupling which is created by sliding. It is preferred here that the walls are free from portions protruding from their main surfaces.

From a further aspect the invention provides a box assembled from the assembly according to the invention.

From a further aspect the invention provides a box designed for use as coffin.

The invention will be elucidated on the basis of a number of exemplary embodiments shown in the drawings, in which:

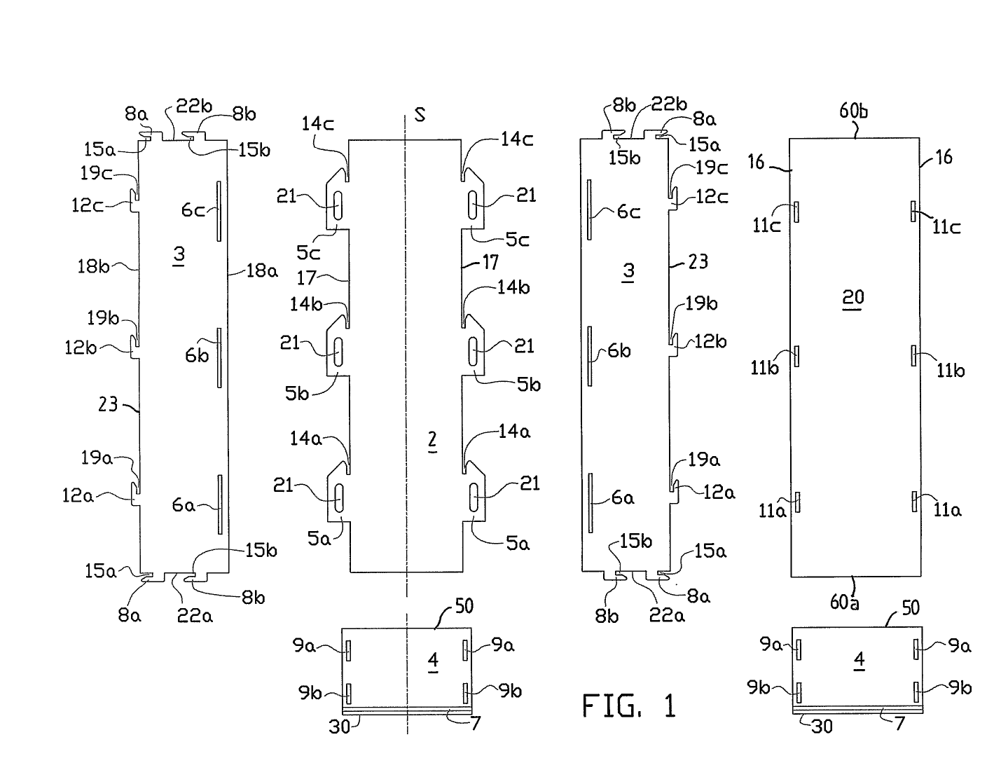

FIG. 1 shows a top view of an assembly of panels suitable for building a first exemplary embodiment of a box according to the invention;

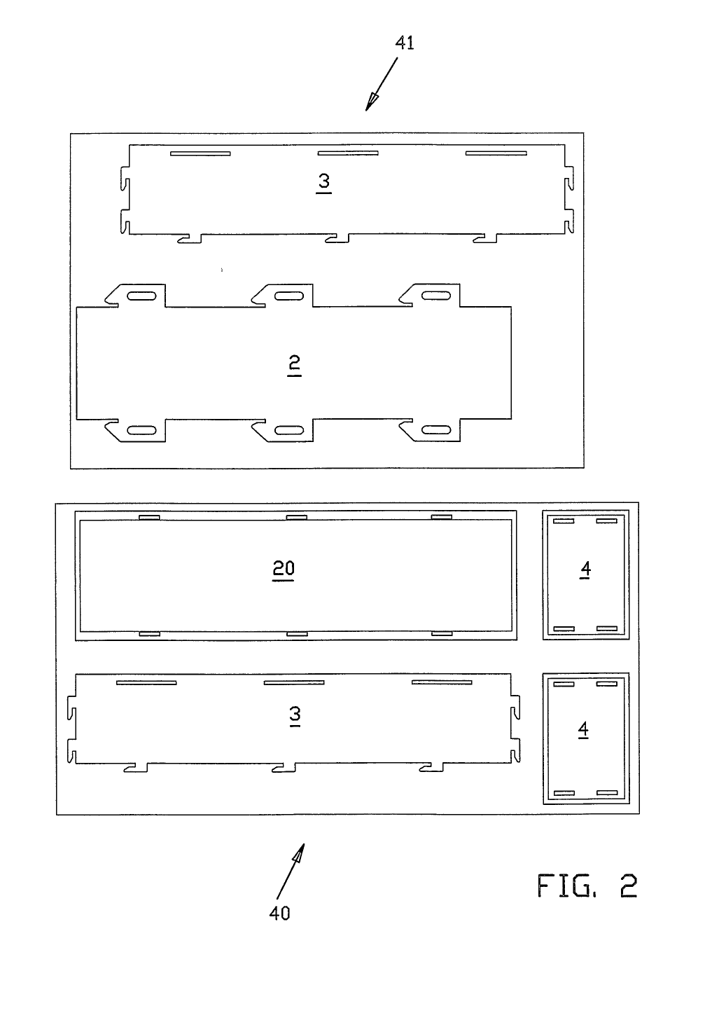

FIG. 2 shows the panels shown in FIG. 1 placed adjacent to each other;

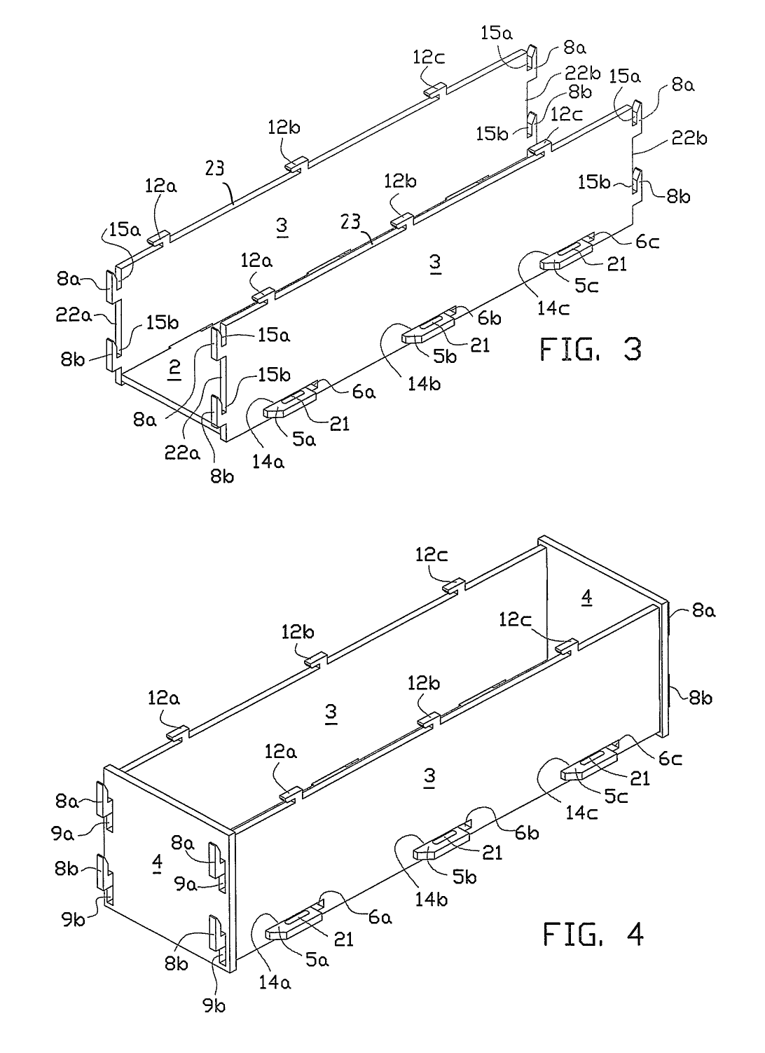

FIG. 3 shows the exemplary embodiment of the box according to FIG. 1, in a first stage of assembling;

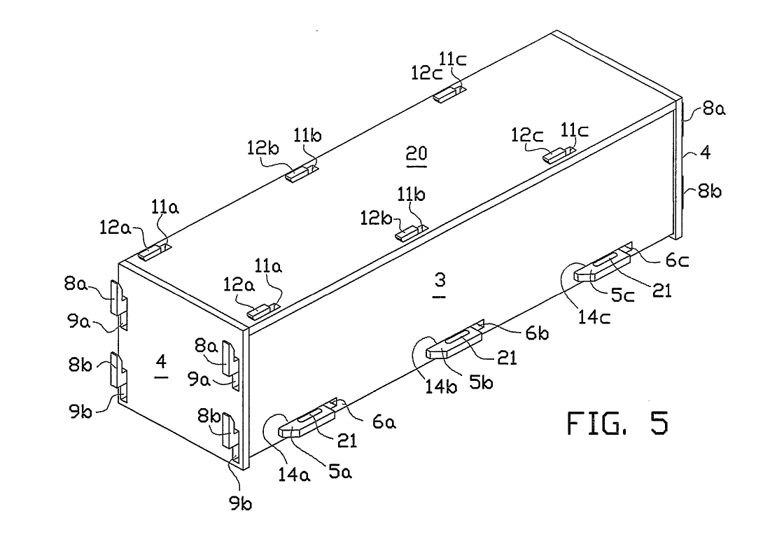

FIG. 4 shows the box of FIG. 1, in a second stage of assembling;

FIG. 5 shows the box of FIG. 1, in closed condition;

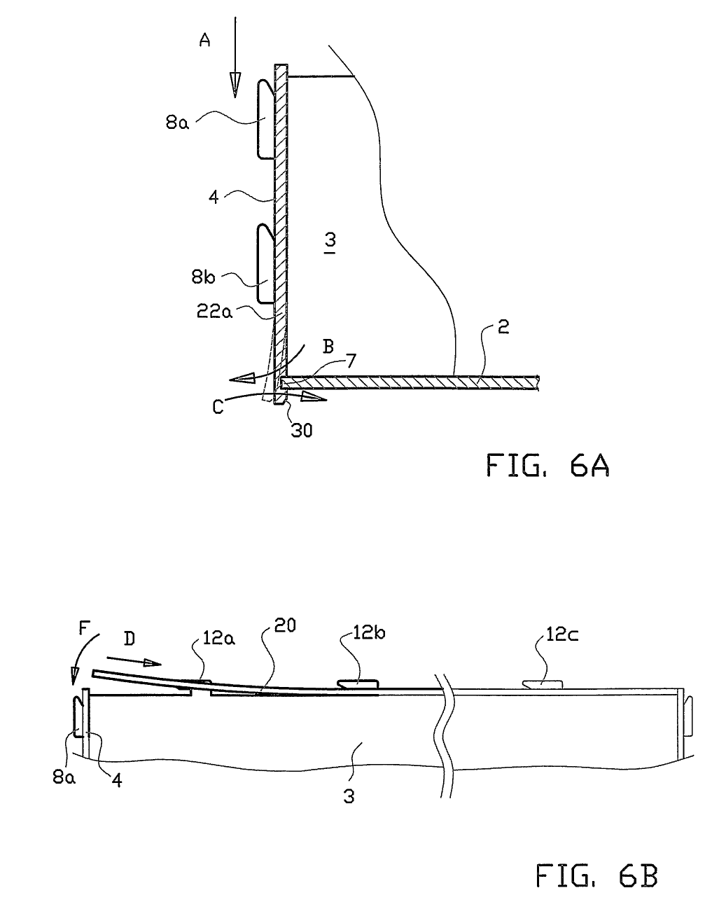

FIGS. 6A and 6B show some details of corner connections at the location of the bottom wall-end wall and upper wall-end wall, respectively;

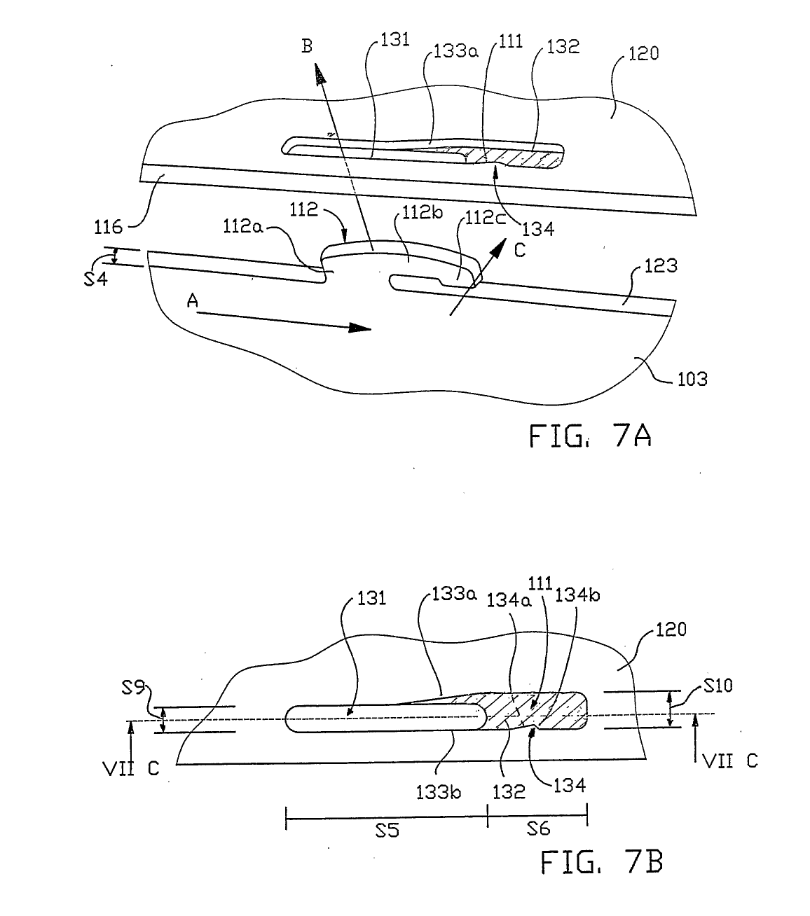

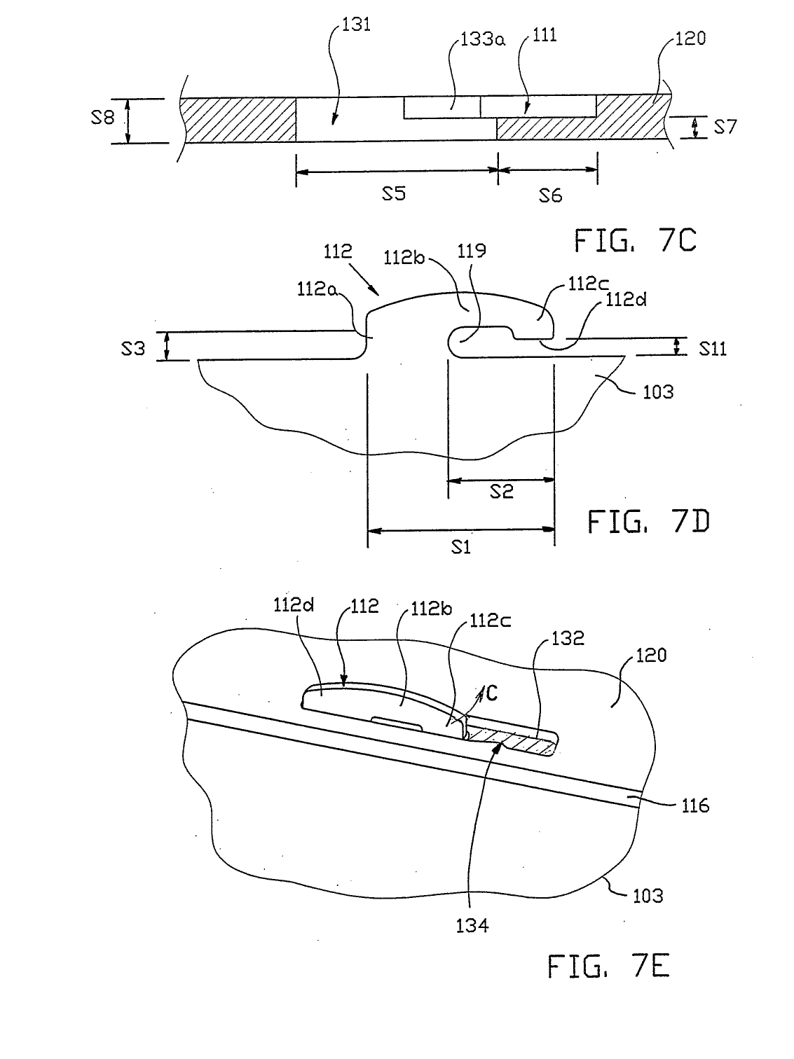

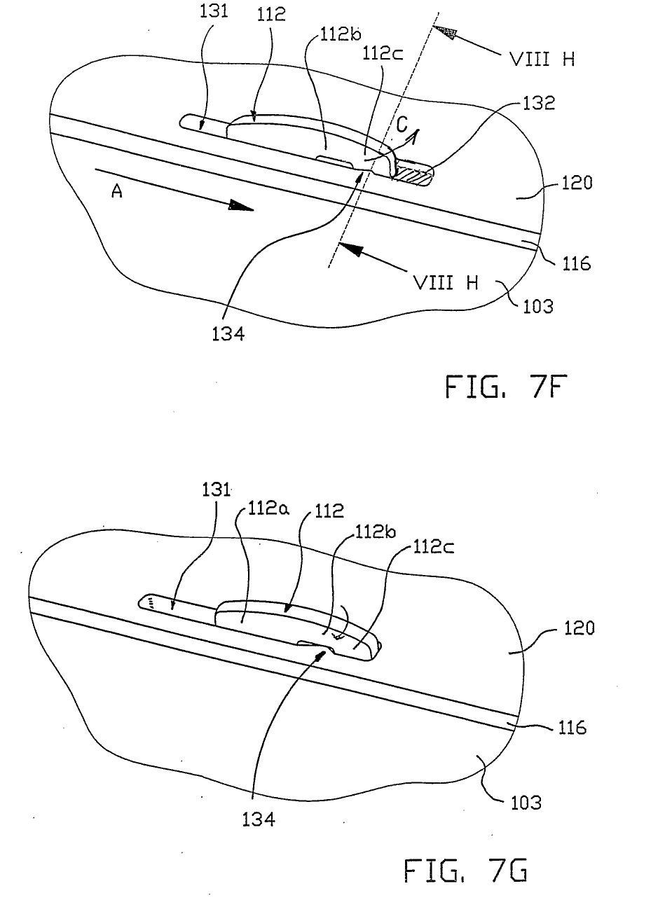

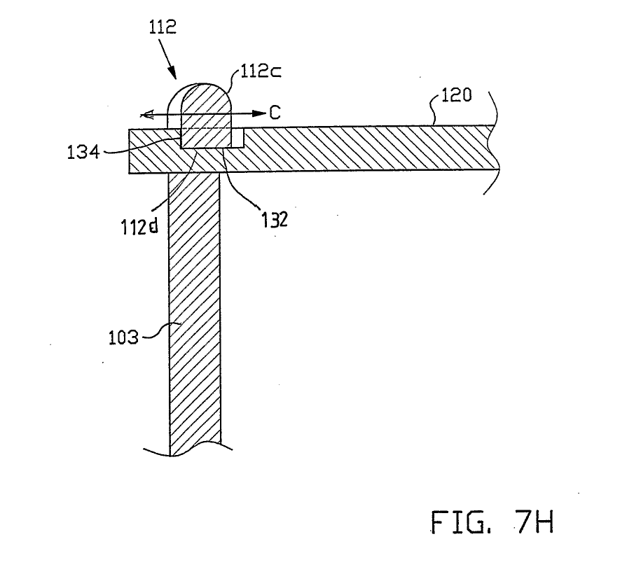

FIG. 7A shows a view in perspective of an assembly of an upper plate having an elongated hole and a bottom plate having a hook for forming a snap connection, in unconnected condition;

FIG. 7B shows a top view of the upper plate according to FIG. 7A;

FIG. 7C shows a cross-section of the upper plate according to line VIIC-VIIC in FIG. 7B;

FIG. 7D shows a side view of the bottom plate with hook according to FIG. 7A;

FIG. 7E shows the first assembly according to FIG. 7A, wherein the upper plate is situated on the bottom plate;

FIG. 7F shows the first assembly according to FIG. 7A, in partially connected condition;

FIG. 7G shows the first assembly according to FIG. 7A, in fully connected condition;

FIG. 7H shows a cross-section of the first assembly according to line VIIH-VIIH in FIG. 7F;

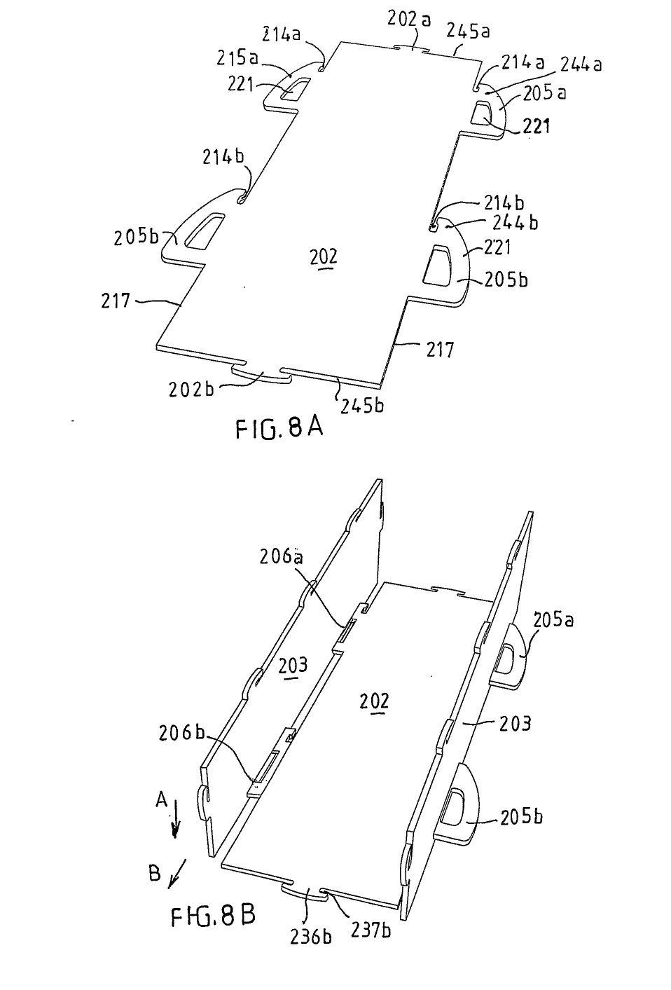

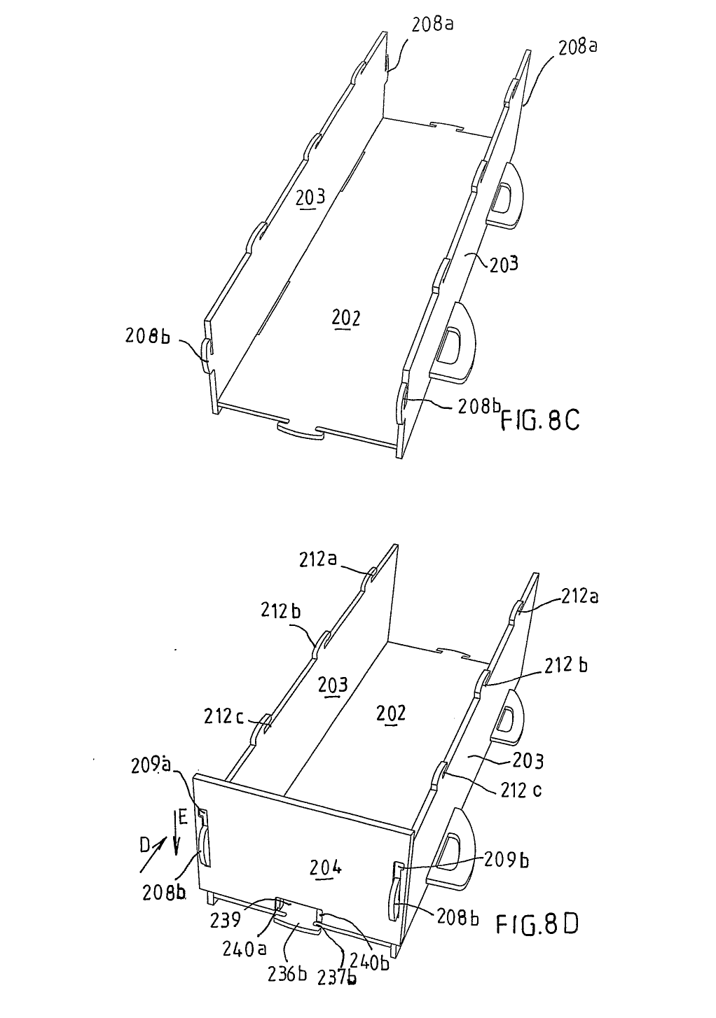

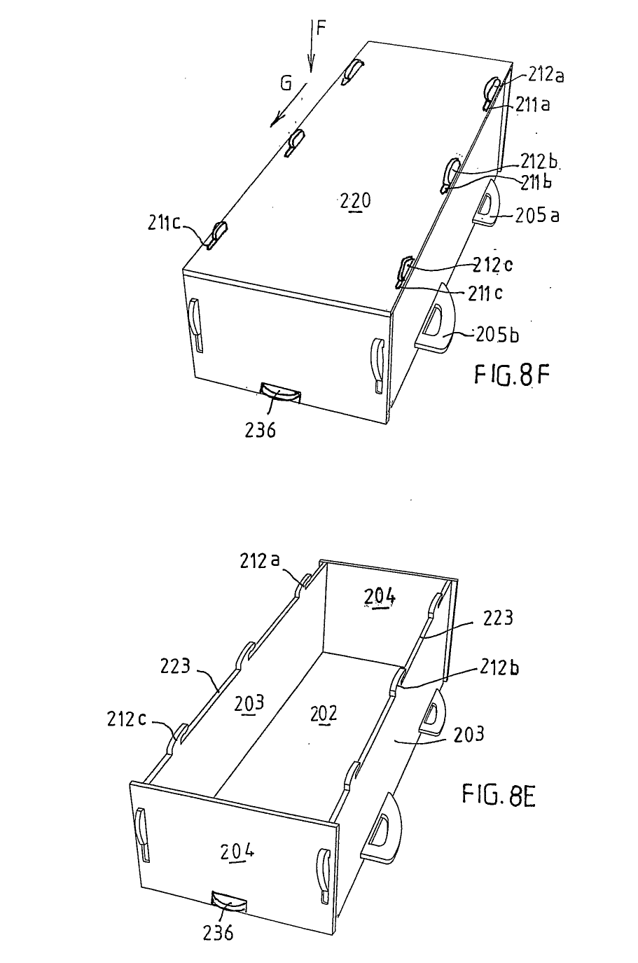

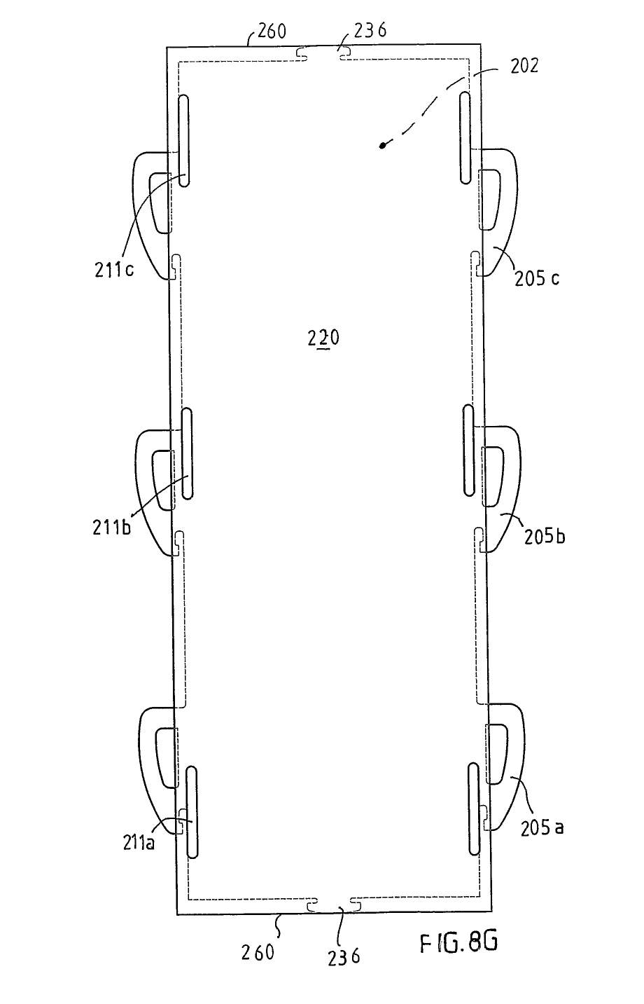

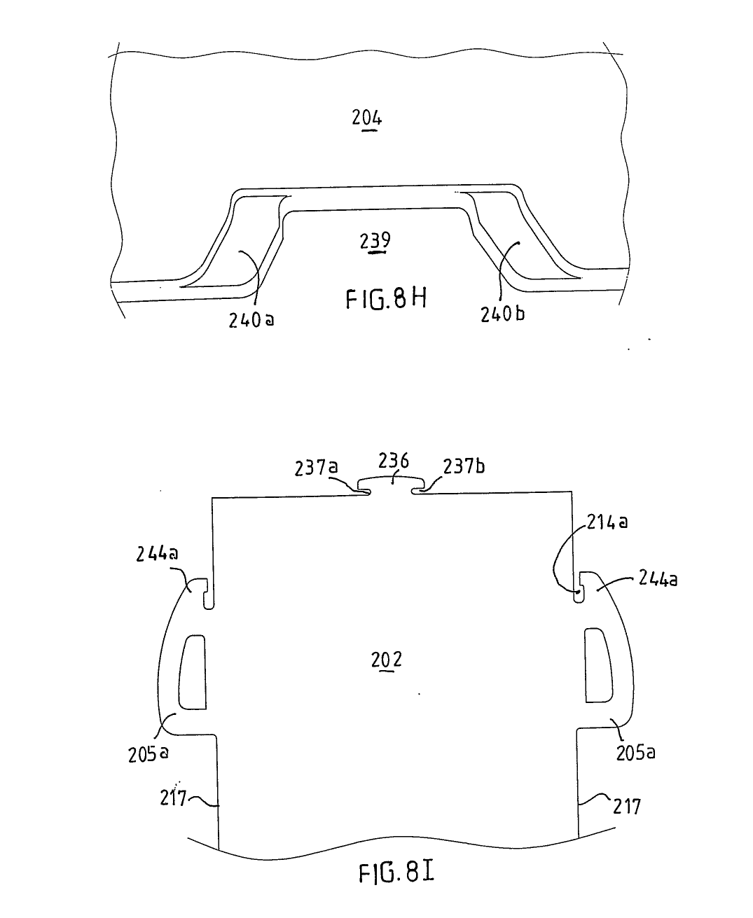

FIGS. 8A-F show consecutive steps in assembling a second exemplary embodiment of a box according to the invention;

FIG. 8G shows a top view of a kit for a box comparable to the one of FIGS. 8A-F;

FIGS. 8H and 81 show details of two panels in the box of FIGS. 8A-F; and

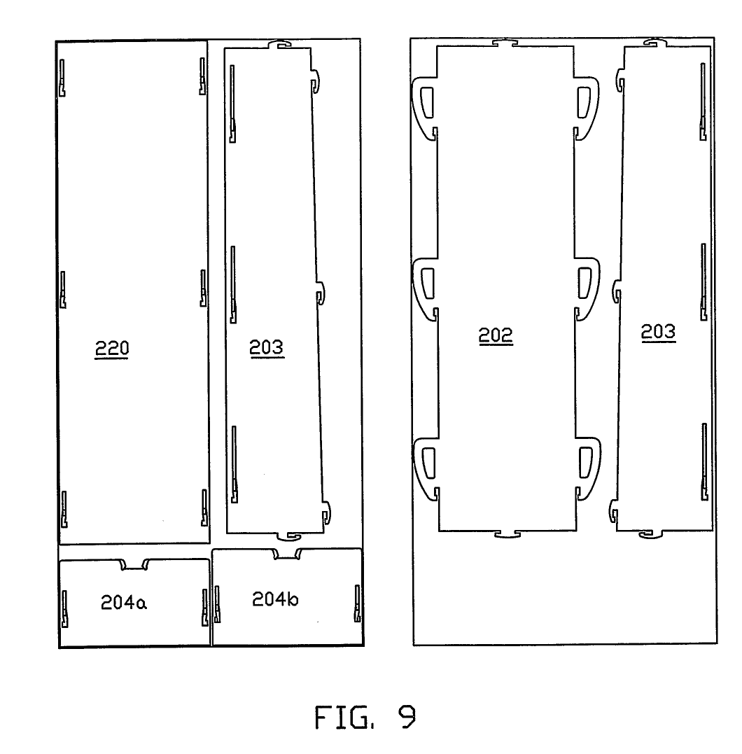

FIG. 9 shows a top view of an assembly of panels suitable for assembling the second exemplary embodiment of the box according to FIGS. 8A-I.

The exemplary embodiment shown in the FIGS. 1-5 of a box 1 according to the invention comprises a bottom panel 2, two side panels 3, 3, two end panels 4, 4 and an upper panel or lid 20. The box 1 has the dimensions to be used as a coffin.

The plate material of which the panels 2, 3, 3, 4, 4 and 20 have been made may for instance be MDF plate material. Water-resistant multiplex can also be used, or other plate materials, that can be cut or sawn and preferably are resistant to weather conditions. The panels may be obtained from the same plate material.

At its longitudinal edges the bottom panel 2 is provided with, in this example, three handle parts 5a, 5b, 5c that have through-holes 21 for engagement by a hand and together with the said longitudinal edge 17 of bottom panel 2 define a slot 14a, 14b, 14c each time equally oriented and provided with an open end. The holes 21, which may for that matter also be used for passing through of a hoist sling, are spaced apart from a notional line coinciding with the edge 17, as a result of which the transfer of forces to the bottom panel 2 is improved.

The side panels 3 are identical and near the lower edge are provided with three slit-shaped openings 6a, 6b, 6c having a slit height corresponding with the thickness of the plate material from which the panels 2, 3, 3, 4, 4 and 20 have been obtained. The length of the slits 6a, 6b and 6c corresponds with the length of the related handles 5a, 5b and 5c.

At the upper edge the side panels 3, 3 are provided with equally oriented, hook-shaped lips 12a, 12b, 12c, which leave a slot 19a, 19b, 19c with the upper edge 18b of side panels 3, 3. The width of the slots 19a-c corresponds with the thickness of the plate material.

At the end edges 22a and 22b similar, equally oriented (upwards) lips 8a, 8b are provided, which with the edges 22a, 22b define slots 15a, 15b of which the width corresponds again with the thickness of the plate material.

Note that the ends of the lips 12a-c and 8a, 8b are bevelled with pilot edges.

The end panels 4, 4 are provided with slits 9a, 9b adjusted to the lips 8a, 8b, wherein the length of the slits 9a, 9b corresponds with the length of the lips 8a, 8b. The panels 4, 4 are symmetrical: at the opposite edges the same lips are present.

Near the longitudinal edges 16 the lid 20 is provided with slits 11a, b, c, for cooperation with the lips 12a, 12b, 12c. The length of the slits 11a-c corresponds with the largest length of the lips 12a-c. The width of the slits 11a-c corresponds with the thickness of the plate material.

The panels 2, 3, 3, 4, 4 and 20 shown in FIG. 1 can be transported and kept in store in stacked package condition. A package for a box 1 may consist of two package layers, such as shown in FIG. 2. The first package layer 40 contains the lid/upper panel 20, one side panel 3, and two end panels 4. The second package layer 41 contains the bottom panel 2 and one side panel 3. Both package layers 40, 41 can be stacked onto each other. With exemplary dimensions of 710×1950 mm for the bottom panel 2, 390×1950 mm for the side panels 3, 590×390 mm for the end panels and 580×1976 mm for the lid, the dimensions b×I of the package layers 40, 41 can be 1200×2500 mm. Packages for several boxes 1 can easily be strapped up using bands or be wrapped in shrink foil.

The package thus obtained can easily be transported to the location of use while taking up little space. An airplane can for instance be loaded with such packages, if somewhere far away in the world a calamity has occurred, causing many casualties.

In the area of use a truck can easily transport the packages further to the location of use.

At the location of use the package is opened, and the bottom panel 2 is laid on the floor. Subsequently the side panels 3, 3 are brought to the edges 17, such that the handles 5a, 5b, 5c extend in the slits 6a, 6b, 6c. When the side panels 3, 3 abut the edges 17 the side panels 3, 3 can be slid along the edges 17, wherein the slots 14a, 14b, 14c accommodate the material of the side walls 3, 3. After this sliding the end edges 22a, 22b of the side panels 3a, 3b are in one vertical plane with the end edges of the bottom panel 2 (FIG. 3). The handles 5a-c and the lips 12a-c extend in the same direction with their free ends.

Subsequently (FIG. 3) the end panels 4, 4 are arranged, wherein while holding them vertically, the slits 9a, 9b are placed over the lips 8a, 8b. Then the end panels 4, 4 are lowered, wherein the material of said panels is accommodated in the slots 15a, 15b. Finally the upper edge of the end walls 4, 4 is at least almost in one plane with the upper edges 18b of the side panels 3, 3 (FIG. 4).

An open box is formed in this way in which a body can be placed. After this is done the lid 20 is taken and placed with the slits 11a, b, c on the lips 12a, b and c of the side panels 3, 3, wherein the lid 20 will support on the upper edges 18b thereof. Subsequently the lid is shifted in longitudinal direction so that its material is accommodated in the slots 19a, b, c. After shifting the lid 20 covers the entire upper opening of the box 1, and its end edges are near the upper edges of the end panels 4, 4 (FIG. 5).

In FIG. 6A the joining of the end walls 4 on the assembly of FIG. 3 is shown in further detail. The end walls 4 are moved downwards in the direction A, wherein the lips 8a, 8b extend in the slits 9a, 9b. At its lower end the end wall 4 is provided with a pilot edge 30, and above it with a groove 7 having a dimension corresponding with the thickness of the bottom wall 2.

In the movement in the direction A, first the pilot edge 30 will abut the edge of the bottom wall 2, and be able to deflect in the direction B, as a result of suitable flexibility of the plate material of the end walls 4. When the groove 7 has arrived at the location of the edge of the bottom wall 2, the lowermost edge portion of the end wall 4 is able to move back in the direction C, creating a kind of snap connection.

In FIG. 6B it is further elucidated how the upper wall or the lid 20 is arranged on the assembly of FIG. 4. The length of the upper wall 20 corresponds with the inside distance between the end walls 4. When placing the upper wall 20 over the lips 12a-c, with the slits 11a-c, the right-hand end edge 60a of the upper wall 20 will able to support on the upper edges 23 of the side walls 3. The left-hand end portion of the upper wall 20, as considered in the drawing, may support on the upper edge 50 of the end wall 4. The upper wall 20 can then be pushed up in the direction D, to the right, wherein the portion between the lips 12a and the left end will become slightly bent, which is made possible by a suitable choice of the plate material. As soon as the left end edge 60b of the upper wall 20 has been moved past the upper wall of the end wall 4, this portion will be able to bend back in the direction F, after which both end edges 60a, 60b of the upper wall 20 are more or less exactly confined between the end walls 4. Should temporary access to the box be necessary, then the left end portion of the upper wall 20, as considered in the drawing of FIG. 6B, can be engaged along the side walls by the hands in order to slightly lift it, and then sliding back the upper wall 20 in one direction opposite to D in order to subsequently remove it.

Due to adjusting the dimension of the width of the various slots and the width of the slits and the thickness of the plate material, firm connections are realised as a result of which the box 1 created in the end can reliably be handled as one unity. No additional fastening means are necessary so that no tools are necessary either. Building the box 1 requires no particular skill.

As the lips and handles are in one plane with the plate material with which they form one unity, the box 1 is built up from six flat plates and the volume and the shape of a stacked package can remain small.

It is noted that the walls, particularly the upper wall, can be split. In case of a split upper wall for instance a part of ¾ of the usual length and a part of ¼ of the usual length can be used. By temporarily leaving out the shorter part it is possible at the location of the head end to provide the opportunity to see the head of the deceased person lying in the box.

FIGS. 7A up to and including 7H show an example of a snap connection for a box according to the invention. The upper panel 120 (first plate) and a side panel 103 (second plate) according to the invention. The upper panel 120 is provided with a slit 111. A through elongated hole 131 (first recess) is formed in the slit 111. In the prolongation of the elongated hole 131 the bottom of the slit 111 forms a supporting plane 132. The elongated hole 131 has a length S5, and the supporting plane has a length S6. The elongated hole 131 has a width S9 and the slit has a width S10 at the supporting plane 132. The upper plate has a thickness S8. The supporting plane 132 is parallel to a lower side of the upper panel 120 at a height S7. As a result the supporting plane 132 is easy to make using a machine.

The side panel 103 is provided with a squared side edge 123 to which at least one hook 112 (hook part) is formed. The hook 112 has a first wider section 112a and, considered in a direction A thereof, a narrower centre section 112b and an end 112c, respectively. At the end 112c an abutment surface has been formed that is parallel to the side edge 123 of the side panel 103. The hook 112 has a length S1 in the direction A. Between the centre section 112b and the end 112c of the hook 112 on the one hand, and the side edge 123 of the side panel 103 on the other hand an accommodation aperture 119 is defined having a length S2. The accommodation aperture 119 has a height S3 underneath the centre section 112b and a height S11 underneath the end 112c. The side panel 103 has a thickness S4.

The hook 112 can be inserted through the elongated hole 131 in a direction B. The centre section 112b and the end 112c of the hook 112 are elastically deformable in direction C transverse to the side panel 103.

The length S5 of the elongated hole 132 is larger than the length S1 of the hook 112. The width S9 of the elongated hole 132 is larger than the thickness S4 of the side panel 103, wherein the width S9 is such that the hook 112 is able to abut the longitudinal walls 133a, b of the elongated hole 131. In this case the hook 112 is able to slide in the direction A in the elongated hole 131.

The length S6 of the supporting plane 132 for instance almost equals the length S2 of the accommodation aperture 119. The height S3 of the accommodation aperture 119 of the hook 112 almost equals the thickness S8 of the upper panel 120. The height S11 of the accommodation aperture 119 of the hook 112 almost equals the height S7 of the supporting plane 132. The width S10 of the slit 111 is larger than the width S9 of the elongated hole 132.

At one longitudinal wall 133a of the slit 111, at the level of the supporting plane 132 a cam 134 (snap cam) is situated, which extends transverse into the slit 111. Considered in the direction A the cam 134 has an upwardly sloping section 134a extending in the slit 111 and contiguously a steeper downwardly sloping section 134b.

The consecutive steps to bring the upper panel 120 and the side panel 103 in a mutual connection at right angles are shown consecutively in FIGS. 7A, 7E-H.

In FIG. 7A the upper panel 120 and the side panel 103 are positioned mutually perpendicular above each other, so that the hook 112 can be inserted through the elongated hole 131 in the direction B, as a result of which the upper panel 120 with its lower side abuts on the side edge 123 of the side panel 103. This is shown in FIG. 7E.

Subsequently, as shown in FIG. 7F, the side panel 103 is shifted with respect to the upper panel 120 in the direction of arrow A, as a result of which the end 112c of the hook 112 with abutment surface 112d will come into engagement with the supporting plane 132 in the slit 111. During this shifting the end 112c of the hook 112 is moved in the direction C by the cam 134, wherein the centre section 112b elastically bends in direction C. The moved position of the end 112c of the hook 112 is shown in cross-section in FIG. 7H.

Subsequently due to moving the side panel 103 further in the direction A, the end 112c of the hook 112 is slid to beyond the cam 134 as a result of which the end 112c of the hook 112 moves back while elastically moving back the centre section 112b. This is shown in FIG. 7G. In this way the centre section 112b of the hook 112 will abut upper panel 120 at the level of the cam 134.

In this shown example the downwardly sloping section 134b of the cam 134 is formed by a plane that is at an obtuse angle to the longitudinal wall 133b. In this way the connection can be ended again due to the side panel 103 moving back. The plane of the downwardly sloping section 134b may alternatively also be perpendicular or at an acute angle to the longitudinal wall 133b, as a result of which a self-locking connection is achieved as moving back in opposite direction to A is blocked.

The embodiment of a coffin/box according to the invention shown in FIGS. 8A-F, comprises a bottom panel 202, side panels 203, end panels 204 and upper panel lid 220, also see FIG. 9. All panels may have the same thickness and may originate from the same plate material. They are free from parts projecting from above or underneath the main surfaces of the panels.

The bottom panel 202 shown in FIG. 8A in this example has four handles 205a, b each having a through-hole 221 and lips 244a, b which with the longitudinal edges 217 define slots 214a, b, wherein the lips 244a, b can be resiliently bend aside with respect to the main plane of the bottom panel 202, in the way as described in connection with FIGS. 7A-H above.

The end edges 245a, b are provided with T-shaped protrusions 236a, b that on either side with the end edges 245a, b define slots 237a, b.

In FIG. 8B already one panel 203 has been placed and the other side panel 203 is being placed. The side panel 203 is first moved in sideward direction A towards the side edge 217 in question of bottom panel 202, wherein the handles 205a, b will extend through the slits 206a, b made in the side panels 203. When the side panels 203 have abutted the side edges 217 the side panel 203 is shifted in the direction B along the side edge 217. The slits 206a, b have been formed in accordance with the slits 111 of the snap connection of the FIGS. 7A-H. When shifting in the direction B therefore a comparable snap connection will be created, wherein the resilient lips 244a, b will for a short while be bent aside out of their plane and then spring back in order to be locked behind said cam. The result of bottom panel 202 and two side panels 203 is shown in FIG. 8C.

Subsequently the end panels 204a, b are placed. A detail of an end panel 204 is shown in FIG. 8H. It shows a part of the lower edge of an end panel 204, provided with a recess 239, which is bounded by a step-shaped edge, as a result of which a lowering 240a, b has been formed. The lowered areas 240a, b form an accommodation space for a part of the protruding arms of the T-shaped protrusion 236a, b. Accordingly the slot 237a, b, also shown in FIG. 81, is less wide than the thickness of the end panel 204.

At the end edges the side panels 203 are provided with lips 208a, b which lips correspond with the lips 112 of the snap connection shown in the FIGS. 7A-H. Likewise the end panels 204 are provided with slits 209a, b that correspond with the slits 111 of the snap connection shown in the FIGS. 7A-H.

When placing the end panels 204 they are first erected in the direction D, wherein the lips 208a, 209b extend through the slits 209a, b.

Subsequently the end panels 204 are shifted downwards in the direction E, wherein in the manner discussed above a snap connection is realised with the lips 208a, 208b and also the arms of the T-shaped protrusion 236b are accommodated (in this case) in the accommodation spaces formed by the lowerings 240a, b (FIG. 8D). Due to the T-shaped protrusion 236 a movement of the lower edge of the end panel 204 with respect to the end edge 245b of the bottom panel 202 is prevented, so that no undesirable slit space may be arise at that location.

After placing the other end panel 204 the situation shown in FIG. 8E is reached. After, in case of a coffin, the corpse has been laid in the box shown in FIG. 8E, the lid 220 can be placed. The lid 220 is provided with a number of slits 211a, b, c, corresponding with slit 111 of the snap connection shown in the FIGS. 7A-H. Likewise the upper edges 223 of the side panels 203 are provided with lips 212, corresponding with lips 112 of the snap connection shown in FIGS. 7A-H. Deviating from the embodiment shown in FIGS. 1-6B, the length of the lid 220 is such that the lid 220 will be able to support on the upper edges of the end panels 204 and on the upper edges 223 of the side panels 203.

The lid 220 is lowered in the direction F, wherein the slits 211a-c move downwards over the lips 112a-c and accommodate them. After the lid 220 supports on the upper edges of the side panels 203 and end panels 204 the lid 220 is shifted in the direction G, in longitudinal direction of the upper edges 223, until the said snap connections have been realised and the lid 220 is locked.

FIG. 8G shows a top view of a stack of panels shown in FIG. 9. It can be seen that the T-shaped protrusions 236a, b are shielded upwards and sidewards by the lid 220. The side panels and end panels are not shown, yet they are situated between the bottom panel 202 and the lid 220. The whole can be packed in a shrink foil (not shown).

It is noted that for the locking of the various panels it will not be necessary to design all interengaging parts as a snap connection. For instance one snap connection may suffice for the lid 220, whereas the other connections can be designed like those of the embodiment according to FIGS. 1-6B. Optionally one snap connection may be provided on both longitudinal sides.

1-26. (canceled)

27. Assembly for forming a coffin, comprising a bottom wall, two longitudinal walls, two end walls and an upper wall, wherein the walls are each plate-shaped, at least a first wall and a second wall being provided with coupling parts directly cooperating with each other and situated in the plane of the plate of the wall in question, wherein the cooperating coupling parts comprise first coupling portions on the first wall and second coupling portions on the second wall to be connected thereto, wherein the first coupling portions comprise slits extending through the plate of the first wall and the second coupling portions comprise lips projecting from the edge of the plate of the second wall, each of which lips with said edge define an aperture or slot accessible at one end, wherein the slot defined by the edge and the lips has a width that is smaller than the thickness of the plate of the second wall, wherein the plate of the first wall provided with the related slit is locally provided with a recess contiguous to the slit for accommodation of at least a portion of one of the lips.

28. Assembly according to claim 27, wherein all said walls are obtained from the same plate material.

29. Assembly according to claim 27, wherein the slits have a width corresponding with the thickness of the plate of the second wall.

30. Assembly according to claim 27, wherein the width of the aperture or slot formed between the edge of the plate of the second wall and the lip almost equals the thickness of the plate of the first wall at the location of the recess.

31. Assembly according to claim 27, wherein the bottom wall is a second wall provided with said lips.

32. Assembly according to claim 31, wherein the lips formed at the bottom wall also form a handle.

33. Assembly according to claim 31, wherein the longitudinal walls are first walls provided with slits for the lips on the bottom wall.

34. Assembly according to claim 27, wherein the end walls are first walls provided with slits for cooperation with lips provided at the end edges of the longitudinal walls forming second walls.

35. Assembly according to claim 27, wherein at their upper edges the longitudinal walls forming second walls are provided with lips and the upper wall forming a first wall is provided with slits cooperating therewith.

36. Assembly according to claim 27, wherein the walls are perfectly flat.

37. Assembly for forming a coffin, comprising a bottom wall, two longitudinal walls, two end walls and an upper wall, wherein the walls have each been made of the same plate material, wherein at least two of the walls are connected/connectable to each other by means of a snap connection.

38. Assembly according to claim 37, wherein the walls are free from portions protruding from their main surfaces.

39. Assembly according to claim 27, wherein at least two of the walls are connected/connectable to each other by means of a snap connection between the first and second coupling portions.

40. Assembly according to claim 37, wherein the snap connection comprises a lip forming one unity with the one wall and which is able to enter into a snap connection with a recess in the other wall, wherein the other wall near the recess is provided with a snap cam.

41. Assembly according to claim 40, wherein the lip when effecting the snap connection is resiliently deformable.

42. Assembly according to claim 27, wherein the upper wall is placeable on both end walls.

43. Assembly according to claim 27, wherein the said walls have been stacked onto each other in the shape of a package.

44. Assembly according to claim 34, wherein the lips provided at the end edges of the longitudinal walls with their open end are upwardly oriented.

45. Assembly according to claim 39, wherein the snap connection locks the first and second coupling portions.

46. Assembly according to claim 41, wherein the lip can be resiliently bent aside with respect to the main plane of the one wall.

47. Assembly according to claim 40, wherein the lip can spring back behind the snap cam in order to be locked.

48. Assembly according to claim 40, wherein said recess in the other wall has a supporting plane for the lip and is formed in a slit in the other wall, said slit comprising a through elongated hole for passing said lip and said recess being located in the prolongation of said elongated hole.

49. Assembly according to claim 40, wherein said recess is located at the side of the other wall facing away from the one wall.

50. Assembly according to claim 38, wherein said at least two walls are connectable to each other by means of a coupling that is created by sliding.

51. Assembly according to claim 27, wherein the said walls have been stacked onto each other in the shape of a package.

52. Assembly for forming a coffin, comprising a bottom wall, two longitudinal walls, two end walls and an upper wall, wherein at least two of the walls are connected/connectable to each other by means of first and second coupling portions provided on a first and a second of the two walls, respectively, said first and second coupling portions forming a snap connection whereby the first and second coupling portions are locked against separation from one another.
